(19) United States
(12) Patent Application Publication
(10) Pub. No.: US 2013/0256996 A1
(43) Pub. Date: Oct. 3, 2013

(54) SHIPLAP PLATE SEAL

(71) Applicant: Matthew Troy Hafner, Honea Path, SC (US)

(72) Inventor: Matthew Troy Hafner, Honea Path, SC (US)

(73) Assignee: GENERAL ELECTRIC COMPANY, Schenectady, NY (US)

(21) Appl. No.: 13/432,650

(22) Filed: Mar. 28, 2012

(51) Int. Cl. F16J 15/02

(52) U.S. Cl. 277/650

(57) ABSTRACT

A seal plate assembly for a turbine rotor includes at least one inner shiplap seal plate disposed on the rotor; and at least one outer seal plate adapted to engage the at least one inner shiplap plate. The thickness of the at least one outer seal plate is different than the thickness of the at least one inner shiplap plate causing either the at least one inner shiplap plate or the at least one outer seal plate to come into contact first under centrifugal load.

### TECHNICAL FIELD

The subject matter disclosed herein relates to gas turbine rotors and, more particularly, is concerned with a seal assembly for sealing coolant passageways in turbine rotor blades disposed in the periphery of a turbine rotor disc.

### BACKGROUND

A typical gas turbine has a rotor (wheel) with a number of blades (buckets) distributed around the circumference of the rotor. The blades may be secured to the rotor using a conventional dovetail configuration. The blades are driven by hot gas from the combustion chamber and are cooled using a coolant that flows through passages in the blades. It is important to avoid the hot gases from coming into contact with the rotor.

A variety of seal configurations have been developed to prevent the hot gases from coming into contact with the rotor. In some cases a full hoop coverplate may be positioned about the rim of rotor to seal off the hot gases. The seal assembly may also seal a cavity between the blades and the rotor disc that allows air to flow to the blades for cooling purposes. In some applications a wire seal may be disposed in a groove in the rotor to provide a more effective seal. Another approach is to provide a seal plate comprising of a number of seal plate segments each having seal wings that isolate the rim cavity from the hot gas path. The seal plate segments may be connected to the rotor using hooks and locking pins that capture the seal plates and prevent them from slipping out of the bladed rotor assembly when the turbine is not spinning, respectively. Wire seals can be used around the seal plates. The segmented seal plates usually rely on tight tolerances to control leakage area.

Full hoop coverplates provide effective seals, but can rarely be used in heavy duty gas turbines due to field maintenance requirements and the difficulty of unstacking the unit rotor in the field. Segmented seals facilitate field maintenance. Segmented seals have the problem that in some cases the seal performance is not satisfactory.

### BRIEF DESCRIPTION OF THE INVENTION

In accordance with one exemplary non-limiting embodiment, the invention relates to a seal plate assembly for a turbine rotor including at least one inner shiplap seal plate disposed on the rotor, and at least one outer seal plate adapted to engage the at least one inner shiplap plate. The seal plates and shiplaps are dimensioned such that when the shiplaps are in contact there is either a gap between the outer seal plate and the rotor or a gap between the at least one inner shiplap plate and rotor or bucket hook.

In another embodiment, a sealing system for a turbine rotor is provided and includes a plurality of inner shiplap seal plates disposed on the rotor. Each inner shiplap seal plate is provided with a first rabbet edge and a second rabbet edge. The system also includes a plurality of outer seal plates where each outer seal plate is adapted to engage the rabbet edge of one of the plurality of inner shiplap seal plates and the rabbet edge of an adjacent one of the plurality of inner shiplap seal plates. The seal plates and shiplaps are dimensioned such that when the shiplaps are in contact there is either a gap between the outer seal plate and the rotor or a gap between the at least one inner shiplap plate and rotor or bucket hook.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a cross sectional view of an embodiment of a rotor assembly incorporating a seal assembly.

FIG. 2 is a cross sectional view of an embodiment of a seal assembly.

### DETAILED DESCRIPTION OF THE INVENTION

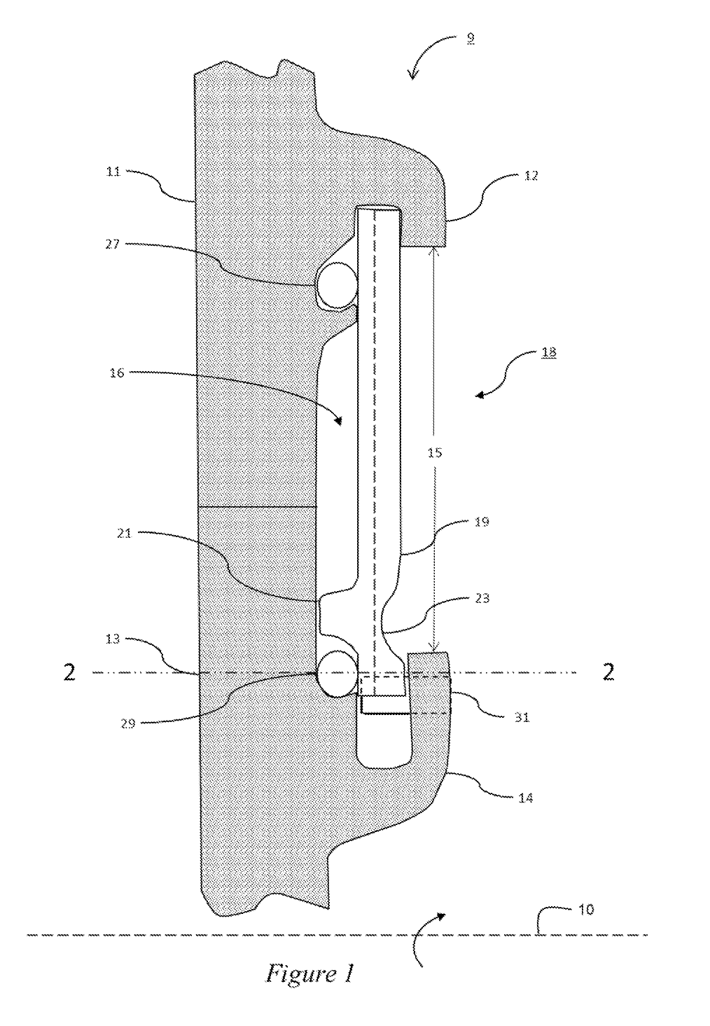

Illustrated in FIG. 1 is an embodiment of a rotor assembly 9 that may be used in a turbine system. The rotor assembly 9 rotates about an axis 10, and may include at least one turbine blade 11 having a blade flange 12. The blade flange 12 protrudes from the turbine blade 11 and angles towards the axis of rotation of the rotor assembly 9. The turbine blade 11 is secured to a rotor 13 by conventional means, such as for example a dovetail structure. The rotor 13 may be provided with a rotor flange 14 that protrudes from the rotor 13 and angles away from the axis of rotation of the rotor assembly 9. The blade flange 12 and the rotor flange 14 define an opening 15 and a chamber 16.

Disposed in the chamber 16 is a seal assembly 18 that may include an inner shiplap seal plate 19. The at least one inner shiplap plate 19 may include a rim 21 and an indented portion 23. The indented portion 23 provides clearance between the at least one inner shiplap plate 19 and the rotor flange 14 when the at least one inner shiplap plate 19 is inserted into the chamber 16. The seal assembly 18 has a radial dimension that is greater than the radial dimension of the opening 15 and smaller than the radial dimension of the chamber 16. The seal assembly 18 may also include an outer diameter wire seal 27, and an inner diameter wire seal 29. The outer diameter wire seal 27 and the inner diameter wire seal 29 may be of any of a variety of cross-section such as for example circular, hexagonal, octagonal, and the like. Additionally, the outer diameter wire seal 27 and the inner diameter wire seal 29 may be a single filament or multiple filaments braided into a rope. The outer diameter wire seal 27 and the inner diameter wire seal 29 may be made of any of a number of known materials as necessary to survive in this operating environment such as high temperature steels, nickel alloys, ceramic, or a combination of any of the materials. The inner diameter seal 29 forms a seal with rim 21 when a centrifugal load is imparted on the inner diameter seal 29. When the rotor assembly 9 is not turning, the at least one inner shiplap plate 19 may be secured to the rotor by conventional means such as, for example pin 31.

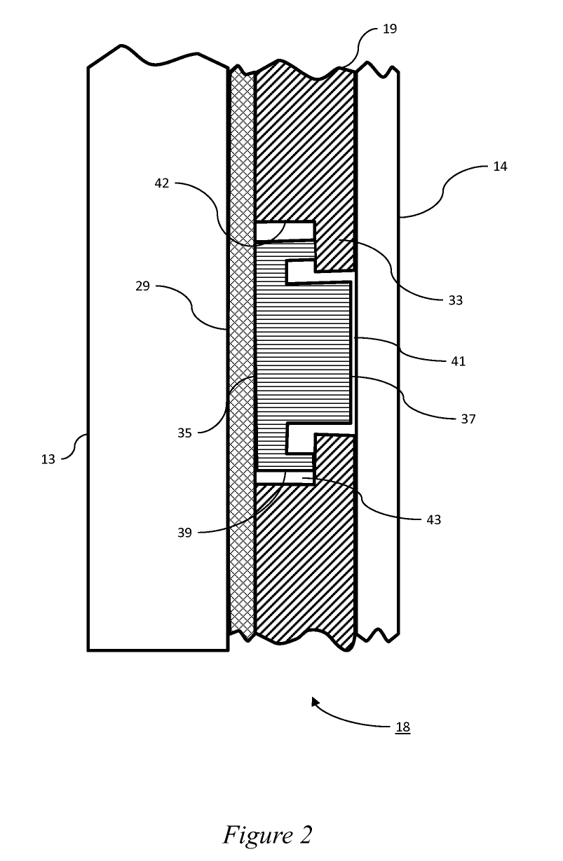

FIG. 2 illustrates a cross sectional view along axis 2-2 of the embodiment of FIG. 1. The seal assembly 18 may include at least one inner shiplap seal plate 19 having a shiplap or rabbet edge 33. An outer seal plate 35 having at a central portion 37 and at least one projection (shiplap) 39 is disposed in contact with the shiplap 33. The dimensions of the at least one inner shiplap plate 19 and the outer seal plate 35 are such that the shiplaps are in contact and there is a slight gap 41 between the outer seal plate 35 and the rotor flange 14 or the at least one inner shiplap plate 19 and the rotor flange 14. The shiplap or projections 39, if included in the design, engage the shiplap 33 and are dimensioned to minimize an air gap 43, while maintaining appropriate clearances between seal plates for installation and thermal growth of the turbine during operation.

The outer seal plate 35 may be disposed between a pair of inner shiplap seal plates 19. Outer diameter wire seal 27 and inner diameter wire seal 29 comprise the top and bottom portion of two sides of the seal that prevents leakage of bucket cooling flow. The shiplaps 33 come into contact first under centrifugal load or due to the wedging of the seal wire between the wheel and seal plate. This system provides a nearly complete sealing circumference around the at least one inner shiplap plate 19 and the outer seal plate 35. The shiplaps 33 are designed to contact first before the outer seal plate 35 itself contacts the turbine wheel, or in an alternate embodiment, the shiplaps 33 are designed to contact first before the at least one inner shiplap plates 19 contact the rotor flange 14. The system can rely on the wedging force of the inner diameter wire seal 29 and the outer diameter wire seal 27 to force contact between the shiplaps 33 or centrifugal force by properly locating the center of gravity of the seal plates segments 19 and the male seal plates 35.

As one of ordinary skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, all of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

What is claimed:

1. A seal plate assembly for a turbine rotor comprising:
a pair of inner shiplap seal plates disposed on the rotor; and
an outer seal plate, the outer seal plate adapted to engage the pair of inner shiplap plate, wherein the thickness of the outer seal plate is different than the thickness of the pair of shiplap plate.

2. The seal plate assembly of claim 1 wherein each of the pair of shiplap plates comprises a main body portion and a rabbet edge portion, and the outer seal plate engages the rabbet edge portion of each of the pair of inner shiplap seal plates.

3. The seal plate assembly of claim 2 wherein the outer seal plate comprises a plate having a central portion that is thinner than each of the pair of inner shiplap plates.

4. The seal plate assembly of claim 2 wherein the outer seal plate comprises a plate having a central portion that is thicker than each of the pair of inner shiplap plates.

5. The seal plate assembly of claim 3 wherein the outer seal plate comprises a projection adapted to engage the rabbet edge portion of one of the pair of inner shiplap plates.

6. The seal plate assembly of claim 1 further comprising at least one seal member disposed in contact with the pair of inner shiplap plates and the outer seal plate.

7. The seal plate assembly of claim 6 wherein the at least one seal member is a wire rope seal.

8. The seal plate assembly of claim 5 wherein the rabbet edge portion defines a first edge and wherein the projection is disposed a predetermined distance away from the first edge, defining an air space between the projection and the first edge.

9. The seal plate assembly of claim 1 wherein at least one of the pair of inner shiplap plates further comprises a rim portion.

10. The seal plate assembly of claim 1 wherein at least one of the pair of inner shiplap plates further comprises an indented portion.

11. The seal plate assembly of claim 1 further comprising a member that secures at least one of the pair of inner shiplap plates to the turbine rotor.

12. A sealing system for a turbine rotor comprising:
a plurality of inner shiplap seal plates disposed on the rotor, each of the plurality of inner shiplap seal plates having a first rabbet edge and a second rabbet edge; and
a plurality of outer seal plates, at least one of the plurality of outer seal plates adapted to engage the first rabbet edge of at least one of the plurality of inner shiplap seal plates, and wherein the thickness of at least one of the plurality of outer seal plates is different than the thickness of at least one of the plurality of inner shiplap plates.

13. The sealing system of claim 12 wherein at least one of the plurality of outer seal plates comprises a plate having a central portion that is thinner than each of the plurality of inner shiplap seal plates.

14. The sealing system of claim 12 wherein at least one of the plurality of outer seal plates comprises a plate having a central portion that is thicker than at least one of the plurality of inner shiplap seal plates.

15. The sealing system of claim 12 wherein one of the plurality of outer seal plates comprises a first edge with a first projection adapted to engage the first rabbet edge of one of the plurality of inner shiplap seal plates and a second edge adapted to engage the second rabbet edge of a second one of the plurality of inner shiplap seal plates.

16. The sealing system of claim 15 wherein the first rabbet edge portion defines a first shiplap edge and wherein the first projection is disposed a predetermined distance away from the first shiplap edge thereby defining an air space between the first projection and the first shiplap edge.

17. The sealing system of claim 12 further comprising an inner diameter wire seal disposed across the plurality inner shiplap seal plates and the plurality of outer seal plates.

18. The sealing system of claim 12 further comprising an outer diameter wire seal disposed across the plurality inner shiplap seal plates and the plurality of outer seal plates.

19. The sealing system of claim 12 wherein at least one of the plurality of inner shiplap seal plates is provided with an indentation along an outer surface thereof.

20. The sealing system of claim 12 wherein at least one of the plurality of inner shiplap seal plates is provided with a rim along an inner surface thereof.
